(19) United States
(12) Patent Application Publication
(10) Pub. No.: US 2003/0037149 A1
(43) Pub. Date: Feb. 20, 2003

(54) Distributed and fault tolerant server system and method

(76) Inventor: Lawrence D. Hess, Northridge, CA (US)

Correspondence Address: MICHAEL D. BEDNAREK, SHAW PITTMAN LLP, 1650 TYSONS BOULEVARD, MCLEAN, VA, 22102, US

(21) Appl. No.: 10/212,086

(22) Filed: Aug. 6, 2002

Related U.S. Application Data
(60) Provisional application No. 60/310,548, filed on Aug. 7, 2001.

(51) Int. Cl. G06F 15/173

(52) U.S. Cl. 709/227; 709/239

(57) ABSTRACT

A distributed and fault tolerant server system and method that includes a plurality of modules networked together. A Log-In Module receives a request from a user to log onto the system and searches clusters of nodes in at least an Online Database, and perhaps other modules, to determine which of the nodes has the fewest number of records. The node with the fewest number of records is selected to act on behalf of the user. To achieve fault tolerance and redundancy, each node is paired with a sister node and each node in the pair mirrors its contents to its sister, whereby when one of the sisters fails, the other can immediately take over the functionality of the failed sister. In a preferred embodiment, the system and method is implemented using a Unix-based system such as Linux and is designed to operate massively multiplayer (MMP) online games.

This application claims the benefit of U.S. Provisional Application No. 60/310,548, filed Aug. 7, 2001, which is herein incorporated by reference in its entirety.

### BACKGROUND

1. Field of the Invention

The present invention relates generally to computer server and data exchange technology and more particularly to systems and methods for providing interactive data exchange among thousands or even millions of users.

2. Background of the Invention

Massively multiplayer (“MMP”) online games are persistent game worlds capable of attracting 500,000 or more people who pay a monthly subscription fee of, e.g., $10-$15 per player, with game play that lasts four years or more for a single game. Presently, while there are believed to be fewer than ten games in current release in the U.S., there are already, in aggregate, over one million subscribers—a figure that is still growing. New games are scheduled for release in the near future.

Online gaming is experiencing an even more explosive growth overseas, and in particular Korea, due in part to widespread broadband penetration and the pervasiveness of online game rooms, called “PC Bangs.” Lineage, a single game from developer NCSoft, already has 4 million subscribers and is generating well over $100 million in annual revenues.

To support these relatively large online gaming communities a significant computer server infrastructure is necessary. Not only is it necessary to handle thousands of simultaneous log-on routines for the thousands of individual online players, but it is also necessary to support continuous computations to effect the interactive nature of these online games.

Heretofore, online server technology has been almost uniformly designed in accordance with either a zone based architecture or a layered server architecture. In the zone system, shown in FIG. 1, one computer is provided for each game world zone and users or clients are associated or paired with a particular zone. In this topology, each computer performs all of the required functionality for the online game player or user. For example, each computer might handle everything having to do with a particular game “world” whereby the computer is responsible for identifying the location of the user and other users, tracking the user's movement, determining when a collision occurs between the user and another user or item, facilitating chat among users, receiving and executing commands, implementing artificial intelligence (Al) functionality, etc.

On the surface, implementing a zone based architecture is the easiest way to develop a shared virtual environment. However, this design has several inherent problems, including:

1. Capacity—only a limited number of users are allowed in each zone

2. Scalability—in order to increase capacity the entire system needs to be replicated

3. Cost—replicating an entire system to increase capacity creates enormous costs

4. Critical failure points—by its very nature, the zone design is not fault tolerant because, if one computer in the system fails, the entire zone that the system is managing goes down

5. Cumbersome code development—each computer is performing the entire range of job tasks, e.g., world state management, movement, commands, chat and Al, resulting in slower performance, higher occurrence of bugs and code failures

6. Difficult live game management—since all processes are integrated into one system, there is a higher risk of introducing bugs into the system when maintaining and updating the game.

Another conventional server architecture for supporting online gaming is the multiplayer client-server, with multiple server architectures, an example of which is shown in FIG. 2. The figure shows multiple servers, with each server serving a number of client players. Such an architecture allows a designer to scale beyond the processor cycle limits that a single server can achieve. In such an architecture, there might be players sharing a zone of interest in the game world, but who reside on different servers. The server-to-server connections transmit packets (world state information) that are required by these players.

In the architecture depicted in FIG. 2 a back layer might handle world state data, while computers in a front layer might handle location, movement, etc. for respective users. Users are generally assigned to a specific front end computer based on their physical, real world, geographic location. In some cases, a client computer handles some front layer functionality.

However, even the multiplayer client-server, with multiple server architectures, topology has several deficiencies, and in particular in the context of online gaming. For example, the architecture is not easily scalable in the sense that the speed at which the network will operate is constrained by the inter-server connection with the slowest link. The inter-server connections that are necessary also inject latency problems, which is a big concern, especially in online gaming. Also, the architecture of FIG. 2 is not designed with fault tolerance as a primary characteristic. Finally, the architecture is costly to operate since the data on each server must be replicated to the other servers.

### SUMMARY OF THE INVENTION

The present invention seeks to improve upon the infrastructure that underlies online gaming. Those skilled in the art, however, will appreciate that the systems and methods described and claimed herein are not limited in application only to the online gaming industry. Indeed, the present invention has applications and may be implemented in a host of contexts including, but not limited to, online gambling (3-D virtual casinos), military simulations (war games), e-commerce applications such as Internet catalog sales, and online learning including virtual education seminars. Thus, when the terms online “game” or “gaming” are used herein, they are meant to include at least these other applications as well.

At a high level, the invention provides an ultra scalable and fault tolerant network application platform that enables mass communication online services.

The present invention overcomes deficiencies found in today's online gaming systems by providing: 1) an exceptionally fault tolerant system design that dramatically improves reliability, scalability and performance in online games; and 2) an affordable, high performance technology solution that saves developers the time and cost of spending, typically, at least a year in the development of server technology needed for online gaming.

One of the innovations of the present invention is the elimination of “Zone” architecture in massively multiplayer (MMP) server design, which has been used in virtually every MMP game designed to date. Zone architecture suffers from inherent problems such as a lack of fault tolerance, capacity and scalability problems, cumbersome code development and difficult live game management. The present invention introduces a distributed process design that delivers a scalable, high performance database with exceptional fault tolerance, thereby significantly improving live game performance and reliability.

Other innovations introduced by the present invention include a reconstituted overall architecture that is comprised of several distinct modules that communicate with one another and a user as will be described in more detail later herein. The modules include a login server, a movement server, a command server, a chat server, an online database, an offline database and an artificial intelligence (Al) server. These elements are also referred to as “modules” in the following description.

More specifically, the present invention takes the server layered architecture methodology a step further. The inventor recognized common requirements in existing shared virtual environments: 1) maintaining the world state, 2) tracking movement of objects in that world, 3) performing commands in the world, 4) communicating among objects in the world (i.e., chat), 5) implementing artificial intelligence, and 6) logging into the environment. Traditionally, all of these job tasks were combined within the same code base running in the same server. In the present invention, however, each of these tasks is broken into separate modules that run independently of each other and communicate individually to the world state, distributing the processing load across multiple systems.

The advantages of such a design are many. Significant cost savings and scalability are achieved due to the modularity, which allows for a highly scalable system in smaller increments and at a significantly reduced cost. For example, in order to increase capacity for 2000 additional users, a system in accordance with present invention would require approximately 5 computers spread between modules to handle the increase. In contrast, a conventional zone system would to have add computers for every zone in the world. For example, it there are 40 zones in a world and one computer handles each zone, then up to 40 additional computers would be required to handle the same increase of 2000 users.

In addition, a unique approach to software design is preferably implemented such that development is modularized for simplicity and extendibility. Also, specific processes needed for the overall application are identified, breaking out each process into separate modules to simplify development cycle. Further, base code for each module is preferably written to allow a skeleton of an application to get up and running quickly, such that it is relatively simple to continue development on modules independently.

The foregoing methodology allows for rapid development, and also isolates bugs for easier identification and remedy. Also, these techniques are suited for C++ software development as C++ is an object oriented (or modular oriented) language, allowing for code reuse in individual modules. Indeed, code can be re-used since the present invention is preferably implemented in a modular format, such that the base code used in individual modules is similar and thus, the base code can be re-used through libraries linked to the individual modules. This speeds up the development process and also decreases the time required for debugging.

The modular nature of the present invention reduces the complexity of the code base because each module only has to perform its specific task, eliminating traditional complexity in the development of shared virtual environment servers. The code base to perform these job tasks is also significantly smaller, shortening the development cycle and reducing the number of bugs in the system. Faster performance also results from modularity and streamlined job tasking.

In a preferred implementation, the systems and methods are implemented on Linux clusters, loads and processing are evenly distributed across the system via a unique login process and indexing, and dynamic fault tolerance is achieved through active archiving. Of course, the present invention can also be implemented with any other Unix-based system or similar system.

Aspects of the present invention will now be explained in more detail below in conjunction with several drawings.

### BRIEF DESCRIPTION OF THE DRAWINGS

FIGS. 1 and 2 illustrate prior art online server architectures.

FIG. 3A and 3B depict, respectively, an exemplary hardware layout and system architecture in accordance with the present invention.

FIG. 4 depicts an exemplary series of steps performed by the Log-In module in accordance with the present invention.

FIGS. 5A and 5B depict an exemplary series of steps performed by the Location module in accordance with the present invention.

FIGS. 6A and 6B depict an exemplary series of steps performed by the Command module in accordance with the present invention.

FIG. 7A and 7B depict an exemplary series of steps performed by the Text module in accordance with the present invention.

FIGS. 8A and 8B depict an exemplary series of steps performed by the Online Database module in accordance with the present invention.

FIG. 9 depicts an exemplary series of steps performed by the Offline Database module in accordance with the present invention.

FIG. 10 depicts an exemplary series of steps performed by the Artificial Intelligence module in accordance with the present invention.

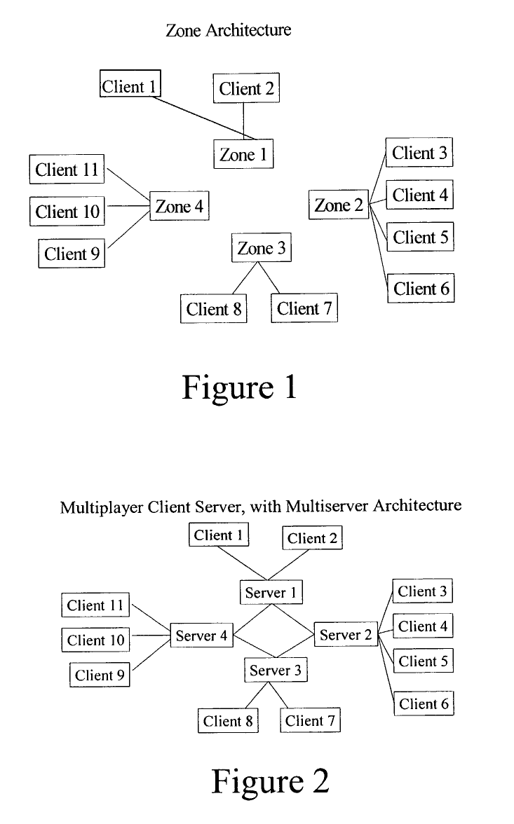

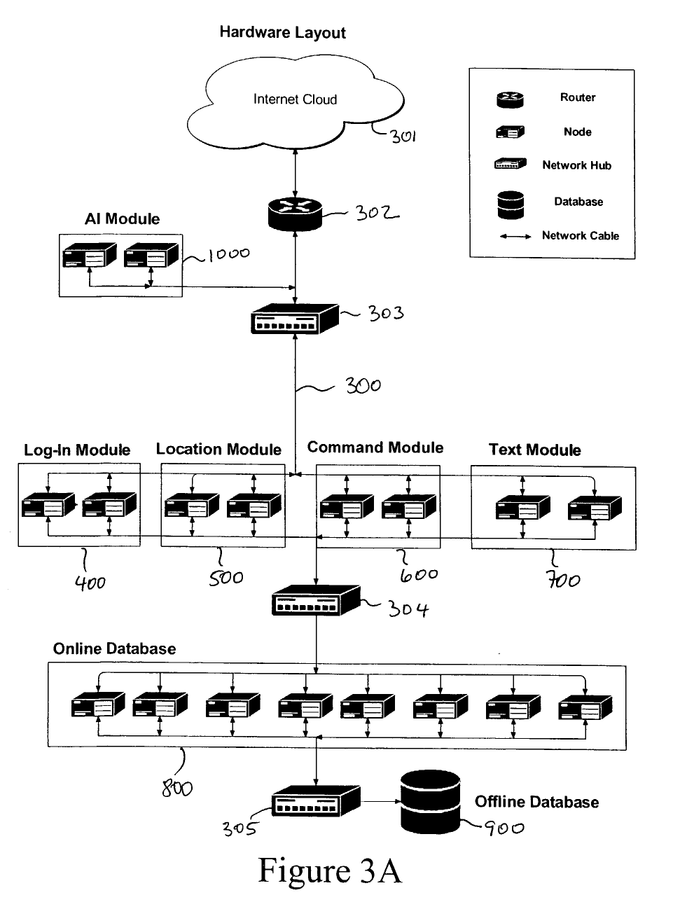

### DETAILED DESCRIPTION OF THE INVENTION

The present invention is configured to improve the performance of massively multiplayer online games and other online systems. These games are designed to allow relatively large numbers of users (e.g. from tens of thousands to hundreds of thousands to millions) to play games within a virtual game world simultaneously. Presently, these virtual game worlds are primarily role-playing or strategy games in which users create avatars (i.e. game characters) to interact with other users' characters in virtual game adventures and quests. Due to the thousands of users playing simultaneously, online communities are created within these game worlds.

Game worlds are maintained on a system of servers. Users log into these games via the Internet from client terminals, such as home computers. In other embodiments, client terminals include game consoles, personal digital assistants (PDAs) and web enabled cellular phones.

In accordance with a preferred implementation of the invention, Linux clusters are employed to perform the designated functionality of the several modules.

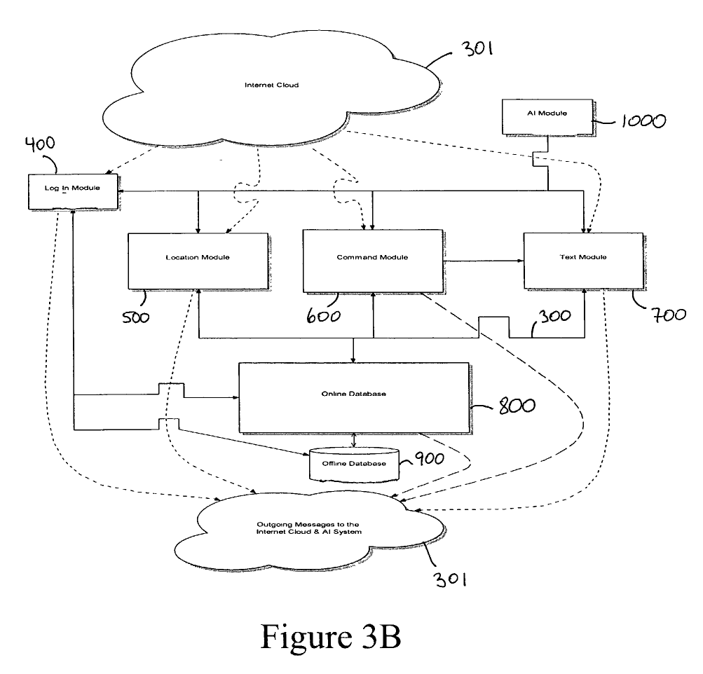

A Linux cluster is a collection of “nodes” (i.e., computers within the cluster) networked together to operate as a single unit and, in this case, using the Linux operating system. As is well-known to those skilled in the art, a system architecture including Linux clusters provides massive scalability. By adding additional nodes to the system, these servers are capable of handling hundreds of thousands to millions of players simultaneously. This scalability is achieved at a significantly reduced cost for equipment compared with other server architectures. FIGS. 3A and 3B shows how each of the modules in accordance with the present invention are connected to each other via network 300. More specifically, router 302 is connected between an electronic network, such as Internet 301, and network hub 303. Network hub 303 is then connected via network 300 to Log-In Module 400, Location Module 500, Command Module 600, Text Module 700, Online Database 800, Offline Database 900 and Artificial Intelligence (Al) module 1000. Network hubs 304 and 305 are disposed in network 300 where necessary to properly interconnect the several components with one another as shown in FIGS. 3A and 3B.

Linux clusters also provide a high level of fault tolerance. Within Online Database 800 records are preferably mirrored to a second node in the cluster. This “sister node” provides redundancy that protects against lost records in the event of a node crashing or being removed for maintenance or repair. This architecture enables the system to rebuild itself automatically in case of node failure, significantly reducing downtime.

Building the system as a distributed database provides dynamic load balancing of users and information. This load balancing takes place within the Log-In Module 400. When Users log onto the system, Log-In Module 400 searches Online Database 800 for the nodes containing the fewest number of records. The new User's records are placed onto these nodes, assuring load balancing throughout the entire system. With information spread evenly across nodes, queries and searches for information within the database are much faster, as nodes have less information to search. In a typical database access to the data is slower because all the data is in one location and searches are performed through the entire database.

Optionally, records within the Online Database are stored in random access memory (RAM) and not in a hard drive. This frees up the I/O to the hard drive allowing the system to perform greater amounts of statistical data collection and logging. This architecture also dramatically increases the speed of the system because it does not have to search the hard drive for information.

A distributed database is also able to handle multiple game databases within the same Online Database 800, thereby allowing the server system to host multiple games on the same system. Game developers can build their own database for a specific game and place it within Online Database 800. Each game preferably has a unique Game ID that refers to the game database that each developer created. This Game ID is located on message headers. This innovation is an improvement in architecture that allows the system to be used again and again, as well as simultaneously, for different games.

As outlined above, the overall system architecture splits the system into multiple modules: 1) Log-In Module; 2) Location Module; 3) Command Module; 4) Text Module; 5) Artificial Intelligence Module; 6) Online Database; and 7) Offline Database. This architecture distributes the CPU load across multiple nodes and breaks down tasks to simpler levels for faster processing times. As a result, this system handles more simultaneous users than in previous architectures. Typically, conventional architectures handle an average of 100 users per node, whereas the architecture of the present invention handles at least 500 users per node.

Multiple modules also allow increased flexibility and customization as the individual modules can be changed or updated without affecting the rest of the system. This is accomplished through scripting engines or plug-ins within each module. The use of such scripting engines and plug-ins are well-known in the art. Each scripting engine or plug-in is customizable for each game and allows the game developer to adapt the system to the specific needs of their game.

This architecture is also scalable as nodes can be added to specific modules that need more processing power.

The modules are preferably networked together using a combination of protocols (e.g., TCP/IP, UDP, MPI and SSL). The MPI protocol is used to communicate to the modules and/or nodes within the system. TCP/IP and UDP protocols are used to communicate to clients (users) over the internet. The SSL protocol is used by the Log-In Module for a secure connection when the system is confirming that a User has an active account.

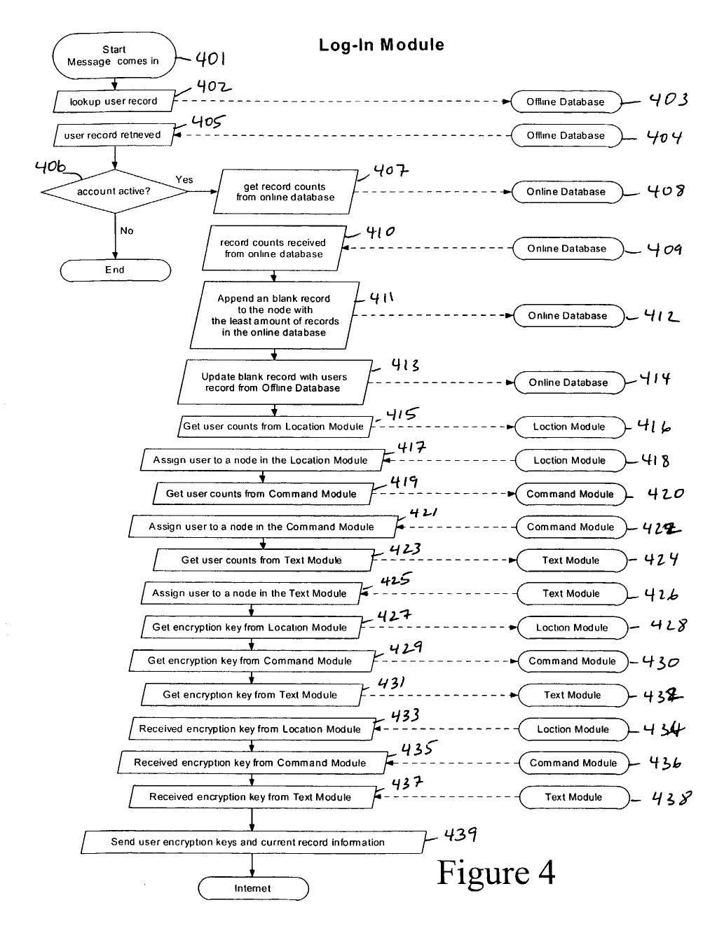

Log-In Module (FIG. 4)

Log-In module 400 is responsible for handling user requests to log into a game.

As shown in FIG. 4, when a message from, e.g., User A comes into Log-In Module 400 at step 401, the module at steps 402-405 first looks up User A's record in Offline Database 900. If User A's record indicates that the account is inactive at step 406 then User A is not admitted to the game and the process ends. If, on the other hand, User A is active, Log-In Module 400 sends a request into Online Database 800 asking for record counts from each node in Online Database 800 (steps 407 and 408). Once Log-In Module 800 has received the record counts (steps 409 and 410), the node in Online Database 800 with the least amount of records receives User A's new record (steps 411 and 412). Once a record is appended to that assigned node inside Online Database 800, User A's record is updated in Online Database 800 (steps 413 and 414) from data in Offline Database 900.

Once User A's record is in Online Database 800, Log-In Module 400 next determines which nodes within the Location Module, Command Module and Text Module User A's record should be assigned to (steps 415-426). Preferably, Log-In Module 800 chooses two nodes with the least amount of records within each of the modules and assigns those nodes to User A. Once all nodes within each module have been assigned to User A, Log-In Module 400 requests an Encryption Key from each module/node (steps 427-438). These Keys are sent to User A at step 439, enabling User A to thereafter communicate with each of the modules. At this point, User A is logged into the system and Log-In Module 800 sends User A his current records, also at step 439.

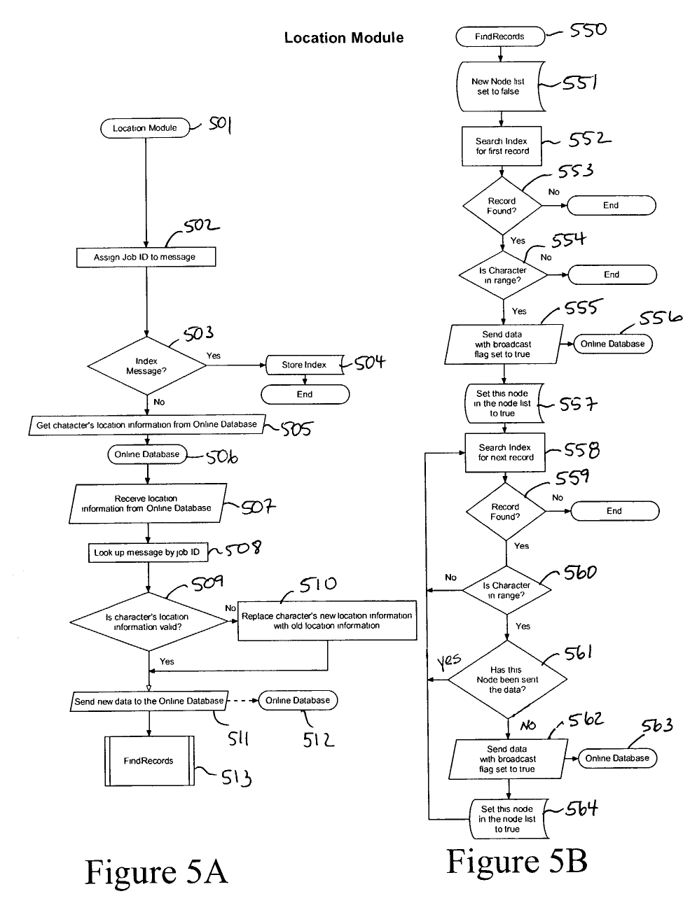

Location Module (FIGS. 5A and 5B)

Location module 500 is responsible for handling location information. This information typically includes User A's current vector, velocity and time that the location message was generated.

When a location message from User A comes into Location Module 500 at step 501, a job ID is assigned to the message at step 502. Then, at step 503, it is determined whether the incoming message is an index message (which is described in more detail below). If yes, then at step 504 the index is stored. More specifically, the index stores index data and the location of which node the record is stored on. Example index data includes player name or location.

If the message is not an index message, then at steps 505-507 Location Module 500 sends an information request to Online Database 800. The responsive message is then looked up by job ID at step 508. It is then determined whether User A's current location and speed information is valid according to the rules set within the game (step 509). If the location information is not valid, the character's new location information is replaced with old location information (step 510). If the location information is valid, User A's location information is stored in Online Database 800 at steps 511 and 512.

Location Module 500 then makes a request at step 513 to identify one or more users in User A's immediate area via a Find Records routine. If User A's location information is invalid according to the rules of the game, the Location Module reverts back to User A's last known legal location and speed, and also broadcasts that information to the other users in the list.

More specifically, as shown in FIG. 5B, the Find Records routine begins at step 550 and at step 551 a new Node list is set to false. Then, at step 552, the location index is searched for a first record. If, at step 553, no record is found then the process ends. If a record is found, then at step 554 it is determined whether the character associated with the record is in range. If the character is not in range then the process ends. If the character is in range, then at step 555 the data is sent to online database at step 556 with a broadcast flag set to true. (A discussion of broadcasting data in Online Database 800 is discussed later herein.) At step 557 the node in the node list is set to true.

At step 558 the index is searched for the next record and at steps 559-564 the process described above is repeated until all records have been located. Step 561 determines whether the node has been sent the data. With the routine of FIG. 5B, it is guaranteed that all of the relevant records that need to be updated in connection with a process in Location Module 500 are indeed updated.

As alluded to above, Location Module 500 also has a built-in job queue system. This job queue is responsible for maintaining all messages. Messages coming into Location Module 500 are placed into the job queue and assigned a Job ID number. All messages going to Online Database 800 have this Job ID number placed in the front of the message. When a message comes back from Online Database 800 to Location Module 500, there is also a Job ID attached to the front of each message that corresponds to the original Job ID number from Location Module 500. This allows Location Module 500 to handle multiple messages at one time.

Location Module 500 also preferably has a built-in scripting engine or plug-in. The scripting engine or plug-in allows event triggers and processes to be performed. For example, if User A's location information is invalid according to the rules of a game, the Location Module's scripting engine or plug-in preferably triggers a process that records that invalid information to a log file for later analysis.

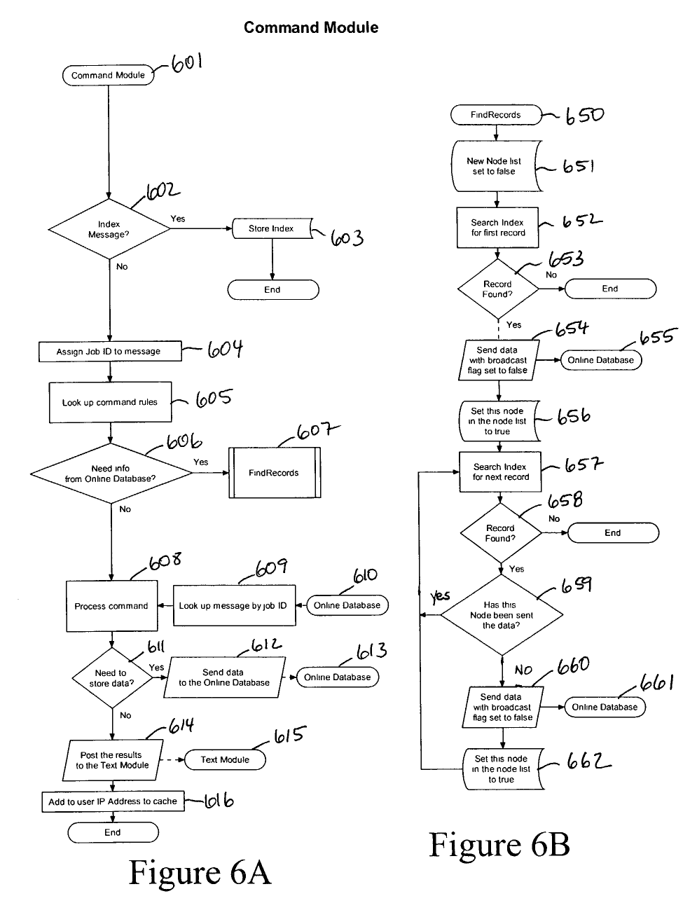

Command Module (FIGS. 6A and 6B)

Command module 600 is responsible for handling Rules in the game and miscellaneous messages. Within Command Module 600 there preferably is a scripting engine or plug-in. The scripting engine or plug-in can be programmed by developers to define the commands and the rules within the Command Module. Typically, each command has scripts or plug-ins attached.

When a message comes into Command Module 600 at step 601 it is first determined at step 602 whether the message is an index message. If yes, then at step 603 the index is stored. As explained before, the index stores the index data and the location of which node the record is stored on. If the message is not an index message, then it is placed into a job queue at step 604 (this job queue operates the same as in the Location Module with each message containing a Job ID number). When it is time for the message to be processed, Command Module 600 runs that command's script at step 605. If information is needed from Online Database 800 to implement a rule, step 606, the appropriate records are identified at step 607. If no additional information is necessary then the command message is processed at step 608. Processing may be performed in conjunction with Online Database 800 as shown in steps 609 and 610. For example, if a command is issued for User A to “attack” User B, a request is sent to Online Database 800 requesting all information about User A and User B. This script or plug-in then checks to see if User A can attack User B based on the rules defined within the script or plug-in. If User A is allowed to attack User B the script or plug-in processes the attack and decides whether it was successful or not based on the rules defined within the script or plug-in. If successful, the script next decides, e.g., how many points to take from User B. The results are stored in the Online Database and then sent to the Text Module, as illustrated by steps 611-615.

Preferably, there is also a cache built into Command Module 600. This cache can be a circular buffer. It is designed to be used in instances when a user repeats the same command over and over in a short amount of time. The cache records which node the user's records are stored on within Online Database 800. With this information the Command Module does not need to broadcast the message across the entire Online Database but instead sends directly to the node that has the user's records for faster turnaround processing. Storing user IP addresses in the cache is illustrated by step 616.

The scripting language or plug-in in Command Module 600 can also be used to run event triggers and logs. For example, the end of a script or plug-in the system can be programmed to store specific information into logs so statistical analysis can be run at a later time.

From step 607 in FIG. 6A the find records process 650 begins. At step 651 a new Node list is set to false and at step 652 a search of the index for the first record is undertaken. At step 653 it is determined whether a record has been found and if not the process ends. If a record has been found, then at step 654 the data is sent to Online Database 800 at step 655 with a broadcast flag set to false. At step 656 the Node on which the record was found is set to true then at step 657 the index is searched again for the next record. If no record if found at step 658 then the routine ends. Otherwise, at step 659, it is determined whether the node has already been sent the data. If not, the process returns to step 657. If yes, then at step 660 the data is sent to Online Database 800 at step 661. At step 662 the node in the node list is set to true and the process returns to step 657.

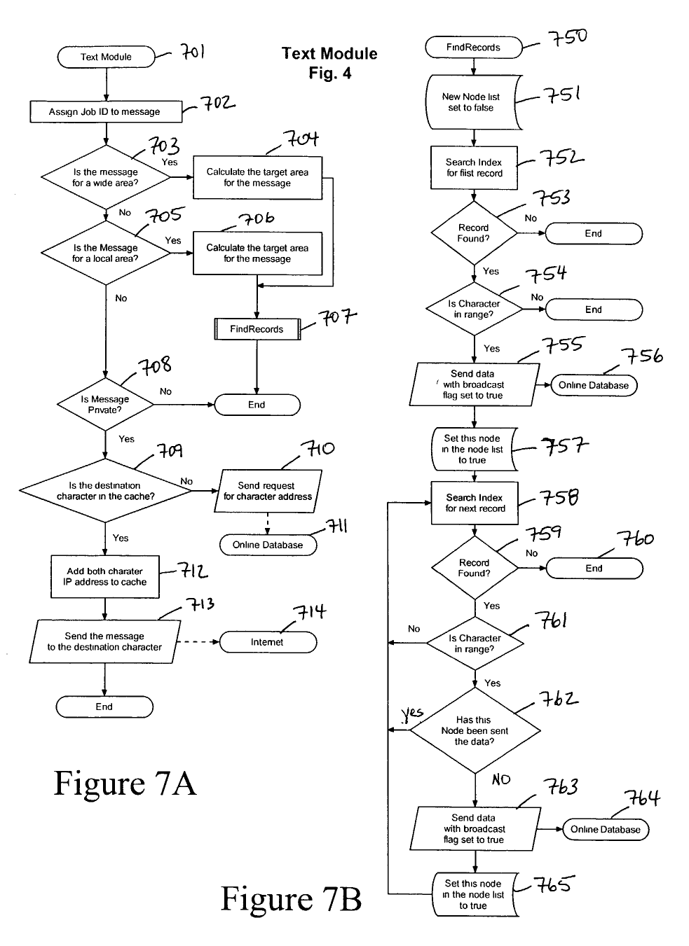

Text Message Module (FIGS. 7A and 7B)

Text message module 700 is responsible for handling text information passed through the “world.” This module sends and receives text messages including chatting and game information messages.

When a text message first comes into text message module 700 at step 701, a job ID is immediately assigned to the message as shown at step 702. Then, at step 703 it is determined if the message is directed to a wide area. If yes, then at step 704 the wide target area is calculated for that incoming message and the process continues with step 707. If the message is not directed to a wide area, then at step 705 it is determined if the message is directed to a local area. If yes, the local target area for the message is calculated at step 706 and the process continues with step 707 in which the appropriate records are identified or the area that has been determined or calculated.

FIG. 7B shows the Find Records routine that is launched from step 707 in FIG. 7A. The steps shown in FIG. 7B correspond to those in FIG. 5B and thus there is no need to again describe this process.

If at step 705 it was determined that the message was not for a local area, it is then determined at step 708 if the message is private. If not, the process ends. If the message is indeed intended to be private, then at step 709 it is determined if the destination character, i.e., be character to which the private message is directed, is stored in the cache (step 712). Then, at step 713 the message if finally sent to the destination character, that character generally being notified of the message via the internet at step 714. The process then ends.

Text Message Module 700 also has a built-in job queue system. This job queue is responsible for maintaining text messages. Text messages coming into Text Message Module 700 are placed into the job queue and assigned a Job ID number. Text messages going to Online Database 800 have this Job ID number placed in the front of the text message. When a text message comes back from Online Database 800 to Text Message Module 700, there is also a Job ID attached to the front of each text message, which corresponds to the original Job ID number from the Text Message Module. This allows the Text Message Module to handle multiple text messages at one time.

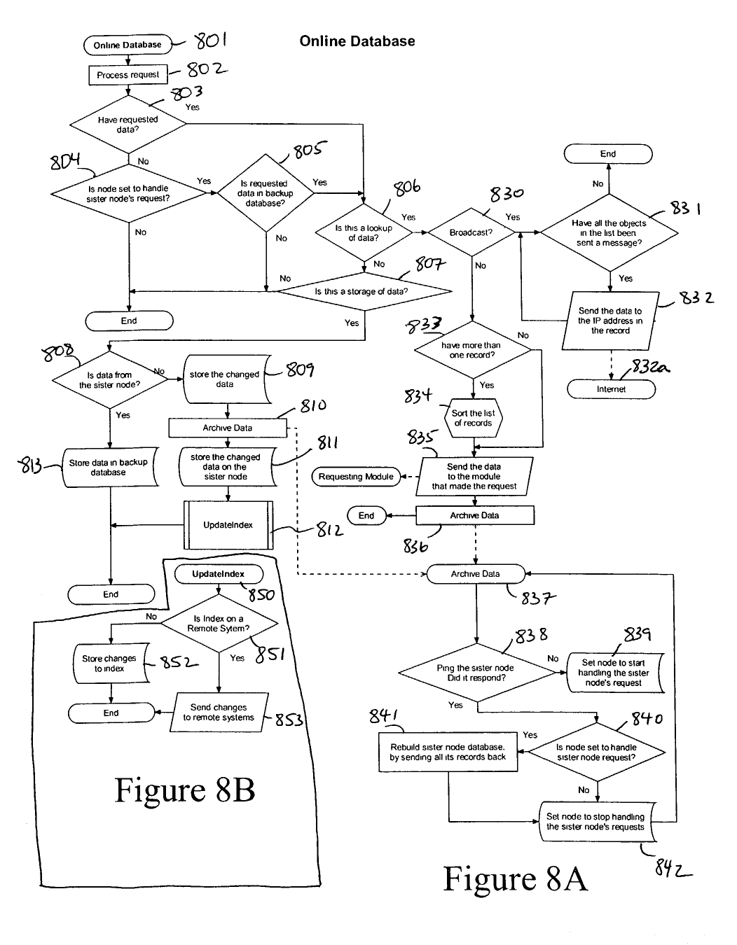

Text Message Module 700 preferably also has a scripting engine or plug-in that is event and trigger driven. Text Module 700 further also preferably has a word filter so profane words and language can be filtered out of text messages. Further, there is also a cache built into Text Message Module 700. This cache is a circular buffer operating similarly to the Command Module cache. This is used when one user communicates directly to another user. It is used to keep each user's IP address so when one user is talking directly with another user the module need not access Online Database 800, but can rather pull the other user's IP address from the Text Message Module's cache, which speeds up response time. Online Database (FIGS. 8A and 8B)

On-Line Database 800 is responsible for handling the data that is active in the game world (also referred to as the “world state”). This database is where records are held when records are moved online from Offline Database 900 when a user first logs on. Online Database 800 is made up of tables and records. The tables are spread across multiple nodes and the records sit on individual nodes. In a preferred embodiment, the command language for the Online Database is a subset of the SQL language.

When a module sends a request for information into Online Database 800, that request is broadcast across the entire network of nodes within Online Database 800. If a node has the record with this information, it sends the information back to the module that requested the information. Information can be received from multiple nodes since information is not distributed in alphabetical order on the nodes, but is rather randomly and evenly spread across all nodes. Accordingly, the search is relatively fast because each node is processing less data.

Online Database 800 preferably includes a scripting engine or plug-in. The scripting engine or plug-in has event triggers to run processes when certain events occur. For example when information in a field changes, the new information is written out to a log so statistical analyses can be run at a later time.

Also, records inside the Online Database are preferably stored in Random Access memory (RAM). This frees up the hard drive I/O so greater amounts of information can be logged without impeding system performance.

According to an aspect of the invention, records are mirrored to a second node in Online Database 800. This protects records in case a node crashes. In the event of a node failure, the second node (“sister node”) picks up the job responsibilities of that node. When the failed node is brought back online, the records that were stored in the sister node are transferred back to the repaired node. This procedure is referred to as “active archiving.”

The scripting engine or plug-in inside Online Database 800 also performs intermittent saves to the Offline Database. This is to store all user information in case of a system crash. If a node crashes, and for some reason the sister node also crashes, records can be restored from the Offline Database.

Functions of Online Database 800 are depicted in FIG. 8A and FIG. 8B. Beginning at step 801, a process request is received at step 802 and it is determined at step 803 whether the requested data is available. That is, it is determined whether the data is in an appropriate index. If not, then at step 804, it is determined whether the node is set to handle its sister node's request. If not, the process ends. If the node is set to handle its sister node's request, then at step 805 it is determined whether the requested data is in a sister node. If not, the process ends. If the requested data is in the backup database (step 805) or the requested data was deemed available at step 803, then it is determined at step 806 whether the process request is a data lookup. If not, it is determined at step 807 whether the process request is a data storage request.

If the process request is neither a lookup request nor a storage request then the process ends.

If the process request was a data storage request, then at step 808 it is determined whether the data is from a sister node. If not, then at step 809 the changed data is stored and then at step 810 the data is archived using an active archiving technique (which will be described later herein with reference to steps 837-842). At step 811 the changed data is also stored on the sister node and then at step 812 an index updating process is performed. This process is described later below with reference to FIG. 8B. Referring back to step 808, if the data is from the sister node then at step 813 the data is stored on the sister node and the process ends.

The index updating process is shown in FIG. 8B and begins at step 850. At step 851 it is determined if the index is on a remote system. If not, then at step 852 changes to the index are stored. If the index is on a remote system, i.e., not in a database local that machine, then at step 853 the changes are sent to the remote system and thereafter the process ends.

Referring again to FIG. 8A and step 806, if the process request is a data lookup then it is determined at step 830 whether the lookup should be broadcast. If the data lookup should be broadcast, then at step 831 it is determined whether all of the objects in a given list have been sent a message. For example, a location message is broadcast to all objects in that area to make sure that each client knows about a move. If all such objects have been sent a message then the process ends. If there are additional objects to send the message to then at step 832 the data is sent to the IP address in the record associated with that object. It is noted that all records have an IP address for the client that owns it. The process then loops back to step 831 to determine if all of the objects have been accounted for. It is also noted that step 832 might also include sending data over the internet, as indicated by reference numeral 832a.

Referring back to step 830 if the data lookup process request is not to be broadcast then at step 833 it is determined whether the process request results in retrieving more than one record. If not, the process continues with step 835. If more than one record has been retrieved then at step 834 the list of records is preferably sorted. Then, at step 835 the data that has been retrieved is sent to the module that made the request. At step 836 the data is archived.

The data active archiving process begins at step 837 and at step 838 it is determined if a response has been received from a sister node that has been pinged. If no response is received, then at step 839 the node is set to start handling the sister node's request. If the sister node did respond then at step 840 it is determined if the node is set to handle the sister node request. If yes, then at step 841 the sister node database is rebuilt by sending all of its records back. Then, at step 842 the node is set to stop handling the sister node's requests. Step 842 also follows step 840 if it is determined that the node is not set to handle the sister node's requests.

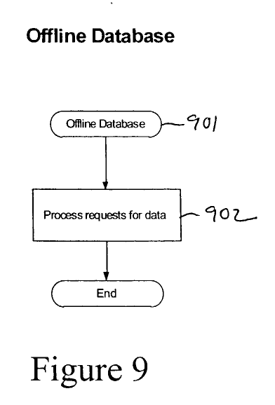

Offline Database (FIG. 9)

This module is responsible for storing records for users. It also stores accounting information for each user. This database is an off the shelf SQL database and processes requests for data (steps 901 and 902) in accordance with well-known techniques.

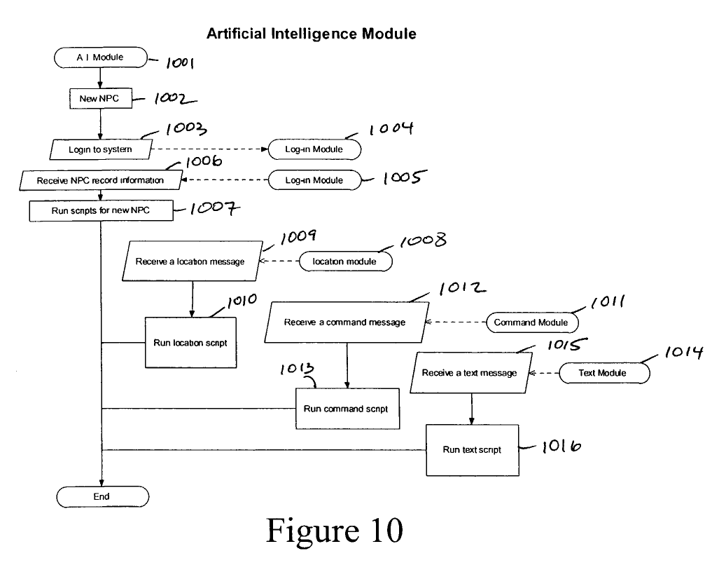

Artificial Intelligence (Al) Module (FIG. 10)

Al module 1000 is responsible for managing all non-player characters (NPCs) in the world. Al Module 1000 typically has a scripting engine or plug-in, which is used to control an NPC's behavior, response rate and the location from where it responds. These NPCs also log into the system through Log-In Module 400, as though they were a conventional user. NPCs play the game as any user would, though the scripting engine or plug-in inside Al Module 1000 controls their behavior.

FIG. 10 illustrates a high level implementation of Al Module 1000. Beginning at step 1001 a new non-player character (NPC) is established and this NPC then logs into the system at step 1003. Login Module 400 is then updated in the way described above at step 1004. At steps 1005 and 1006 the NPC receives record information from Log-In Module 400 and then at step 1007 the scripts can be run for the NPC. The NPC can not only be proactive, but it can also be interactive. That is, as shown by steps 1008-1016, any one of the Location Module, Command Module or Text Module can send a message to the NPC and the NPC will thereafter run an appropriate script in response to that message.

In an actual implementation of the present invention, two message structures are employed: one is for messages that are destined for the internet, and the other is for messages passing between process managers (modules) and databases with the system. Below are exemplary fields for each message structure.

Internet message structure:
typedef struct {

| | |
|---|---|
| long type; | // Task ID. This ID is the procedure that is |
| | // called when the message arrives |
| long reply; | // The replied field is used to send back the |
| | // contents of this field as soon as it arrives. |
| | // If reply is set to 0 then nothing will happen |
| int gameid; | // This is the unique ID to a game. |
| | // No other game has the same ID |

}MSG_GEN_DATA;
Internal message structure:
typedef struct {

| | |
|---|---|
| long type; | // Task ID. This ID is the procedure that will |
| | // be called when the message arrives |
| long reply; | // The replied field is used to send back the |
| | // contents of this field as soon as it arrives. |
| | // If reply is set to 0 then nothing will happen |
| int gameid; | // This is the unique ID for a game. |
| | // No other game has the same ID |
| long jobid; | // Job id is used to track the individual jobs that |
| | // are being sent to a database. |
| | // These job ID's are set by you the developer. |
| long database; | // This is the database id that is to be accessed. |
| long prosstype; | // Process type is set by the process manager. This is |
| | // used for the database to know where to send |
| | // information back. |

}DB_MSG_GEN_DATA;

As will be appreciated by those skilled in the art from the description above, the present invention includes numerous new and unique features and advantages when compared to conventional server systems, especially those that cater to online game players, even though the present invention also has applications in a myriad of other contexts, such as online learning, online gambling, corporate training/employee training, military simulations, e-commerce and large scale data retrieval, like that used in biotechnology research.

One of the key elements of the present invention is the overall online distributed database. A login module searches the online database for the nodes containing the least amount of records and assigns a new user's record on those nodes, thereby assuring load balancing throughout the entire system. Accordingly, queries and searches for information within the database are much faster, as nodes have less information to search. To further speed up database searches, records are preferably stored in random access memory (RAM) rather than respective hard drives. This frees up I/O to the respective hard drives allowing the system to perform greater amounts of statistical data collection and logging.

Further in accordance with the present invention, the distributed database allows the system to handle multiple game databases within the same online database. By using a unique game ID in every message that passes in and out of the system, it is possible to host several games or other applications as desired.

The present invention also comprises a unique architecture that allows indexes to be remotely placed anywhere in the system. Thus, each module can have its own index to access the database, thereby allowing system developers to configure their systems in any way desired. With indexes in each module, developers can perform searches on the databases without having to submit a query into the database itself. This significantly speeds up processing, reducing latency and improving overall game performance.

In a particularly innovative feature, the present invention also eliminates the bottleneck created in conventional server systems, which typically have only one access point through which all messages come in and go out. In contrast, the present invention is designed to allow messages to flow in and out of the system like a river, with messages entering through a module and moving out through a database. This is shown graphically in FIG. 3B. The advantage of this architecture is that messages submitted to a module are passed into the distributed database where multiple computers can handle the query, and messages can be broadcast out to the internet from any of the computers within the database. This design reduces the overall distance that messages must travel through the system, thereby greatly reducing latency in games (or other applications) and dramatically improving processing speed.

In addition to all the foregoing, the present invention implements an active archiving process whereby nodes of clusters are paired together and information stored on respective pairs of nodes is mirrored to the other, or sister, node. This provides significant redundancy and fault tolerance thereby ensuring continuous system processing.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A server system, comprising:
a Log-In Module;
at least one of a Location Module, Command Module, and Text Module; and
an Online Database in communication with said Log-In Module and said at least one of a Location Module, Command Module, and Text Module, the Online Database comprising a plurality of servers,
wherein in response to a request to log in a user, said Log-In Module obtains record counts from each of the plurality of servers in the Online Database, determines which of the plurality of servers has the least amount of records and designates one of the plurality of servers with the least amount of records to perform functions on behalf of the user.

2. The system of claim 1, wherein the at least one of a Location Module, Command Module, and Text Module is comprised of a plurality of servers.

3. The system of claim 1, wherein the plurality of servers is arranged in clusters.

4. The system of claim 1, further comprising an Offline Database.

5. The system of claim 1, wherein each server comprises at least one node and each node is paired with a sister node.

6. The system of claim 5, wherein a first sister node takes over the functionality of a second sister node, when the second sister node fails.

7. The system of claim 1, wherein the system supports a massively multiplayer (MMP) online game.

8. The system of claim 1, wherein the system supports at least one of online gambling, military simulations, e-commerce, employee training and online learning.

9. The system of claim 1, further comprising an Artificial Intelligence Module.

10. A method of conducting a massively multiplayer online game, comprising:
receiving a request from a user to log into an online game;
obtaining record counts from each of a plurality of nodes in an Online Database;
determining which node of the plurality of nodes has the fewest number of records;
appending a blank record to the node with the fewest number of records;
updating the blank record with user information;
assigning the user to a node in at least one of a Location Module, Command Module, and Text Module; and
receiving a message that is to be directed to said at least one of a Location Module, Command Module, and Text Module.

11. The method of claim 10, further comprising identifying records in other nodes based on the message.

12. The method of claim 10, further comprising, accessing an Offline Database to retrieve the user information.

13. The method of claim 12, wherein the user information contains financial account information.

14. The method of claim 10, further comprising receiving a plurality of messages from a plurality of users.

15. The method of claim 10, further comprising determining whether the message is a data lookup message or a data storage message.

16. The method of claim 10, further comprising maintaining an index of the records stored in each node.

17. The method of claim 10, further comprising actively archiving information stored on each of the nodes by mirroring the stored information on a designated sister node.

18. The method of claim 10, further comprising logging in a non-player character, which is generated by an Artificial Intelligence Module.

19. The method of claim 10, wherein the message comprises a game ID to identify a predetermined game to which the message is directed.

20. The method of claim 10, wherein at least the Log-In Module and Online Database are in communication with the internet.

21. The method of claim 10, further comprising simultaneously hosting a plurality of massively multiplayer online games.

22. A system for coordinating interactions among a plurality of remote users, comprising:
an online database that stores records regarding each of the plurality of remote users a plurality of interconnected modules in communication with the online database, wherein each module is responsible for at least one primary function; and
a login module via which the plurality of remote users access the system and which is operable to access individual nodes in the online database and to determine which of those nodes are handling the fewest number of records.

23. The system of claim 22, further comprising an artificial intelligence module that functions as at least one of the plurality of remote users.

24. The system of claim 22, wherein the plurality of interconnected modules includes at least one of a location module, a command module and a text module.

25. The system of claim 22, wherein the system is used to coordinate interactions among a plurality of online game players.

26. The system of claim 25, wherein the online game is a massively multiplayer online game.

27. The system of claim 22, wherein at least one of the plurality of modules has separate input and output communications pathways to/from an electronics communications network.

28. The system of claim 27, wherein the electronics communications network comprises the internet.

29. The system of claim 22, wherein the system employs remote indexing techniques.

30. The system of claim 22, wherein the online database stores information regarding the plurality of users primarily in random access memory, and utilizes hard drive memory primarily for logging statistical data.

31. A system for coordinating interactions among a plurality of remote users, comprising:
means for storing records regarding each of the plurality of remote users;
means for interconnecting modules that are in communication with the means for storing records, wherein each module is responsible for at least one primary function; and
means for logging in remote users that is operable to access individual nodes in the means for stroring records and to determine which of those nodes are handling the fewest number of records.

32. The system of claim 31, wherein the means for storing records comprises a database that is accessible by the remote users.

33. The system of claim 31, wherein the means for storing records comprises clusters of nodes.

34. The system of claim 33, further comprising means for identifying individual records stored on the nodes.

35. The system of claim 34, further comprising means for broadcasting a message to the nodes to update the records stored on the nodes.

36. The system of claim 31, wherein the system operates as an online game.

37. The system of claim 36, wherein the online game is a massively multiplayer game.

38. The system of claim 31, wherein the modules include at least one of a means for handling location messages, a means for handling command messages and a means for handling text messages.
